(19) United States
(12) Patent Application Publication
(10) Pub. No.: US 2012/0027277 A1
(43) Pub. Date: Feb. 2, 2012

(54) INTERACTIVE ITERATIVE CLOSEST POINT ALGORITHM FOR ORGAN SEGMENTATION

(75) Inventors: Torbjoern Vik, Hamburg (DE); Daniel Bystrov, Hamburg (DE); Roland Opfer, Hamburg (DE); Vladimir Pekar, Toronto (CA)

(73) Assignee: KONINKLIJKE PHILIPS ELECTRONICS N.V., EINDHOVEN (NL)

(21) Appl. No.: 13/262,708

(22) PCT Filed: Mar. 2, 2010
(86) PCT No.: PCT/IB10/50898

§ 371 Date: Oct. 3, 2011

Related U.S. Application Data
(60) Provisional application No. 61/166,265, filed on Apr. 3, 2009.

(51) Int. Cl. G06K 9/00

(52) U.S. Cl. 382/128

(57) ABSTRACT

A system and method for segmenting an image of an organ. The system and method including selecting a surface model of the organ, selecting a plurality of points on a surface of an image of the organ and transforming the surface model to the plurality of points on the image.

### BACKGROUND

Segmentation is the process of extracting anatomic configurations from images. Many applications in medicine require segmentation of standard anatomy in volumetric images as acquired through CT, MRI and other forms of medical imaging. Clinicians, or other professionals, often use segmentation for treatment planning.

Segmentation can be performed manually, wherein the clinician examines individual image slices and manually draws two-dimensional contours of a relevant organ in each slice. The hand-drawn contours are then combined to produce a three-dimensional representation of the relevant organ. Alternatively, the clinician may use an automatic segmentation algorithm that examines the image slices and determines the two-dimensional contours of a relevant organ without clinician involvement.

Segmentation using hand-drawn contours of image slices, however, is time-consuming and typically accurate only up to approximately two to three millimeters. When drawing hand-drawn contours, clinicians often need to examine a large number of images. Moreover, the hand-drawn contours may differ from clinician to clinician. In addition, automatic algorithms are often not reliable enough to solve all standard segmentation tasks. Making modifications to results obtained by automatic algorithms may be difficult and counterintuitive.

### SUMMARY OF THE INVENTION

A method for segmenting an organ including selecting a surface model of the organ, selecting a plurality of points on a surface of an image of the organ and transforming the surface model to the plurality of points on the image.

A system for segmenting an organ having a memory storing a compilation of surface models to be selected, a user interface adapted to allow a user to select a surface model from the memory and select a plurality of points on a surface of an image of the organ and a processor transforming the surface model to the plurality of points on the image.

A computer readable storage medium including a set of instructions executable by a processor. The set of instructions operable to select a surface model of the organ, select a plurality of points on a surface of an image of the organ and transform the surface model to the plurality of points on the image.

### BRIEF DESCRIPTION OF THE DRAWINGS

FIG. 1 shows a schematic drawing of a system according to one exemplary embodiment.

FIG. 2 shows a flow chart of a method to segment an organ according to an exemplary embodiment.

### DETAILED DESCRIPTION

The exemplary embodiments set forth herein may be further understood with reference to the following description and the appended drawings, wherein like elements are referred to with the same reference elements. The exemplary embodiments relate to a system and method for organ segmentation. In particular, the exemplary embodiments provide for organ segmentation by selecting a limited set of points in relation to a surface of the organ, as shown in volumetric medical images acquired through medical imaging techniques (e.g., MRI, CT).

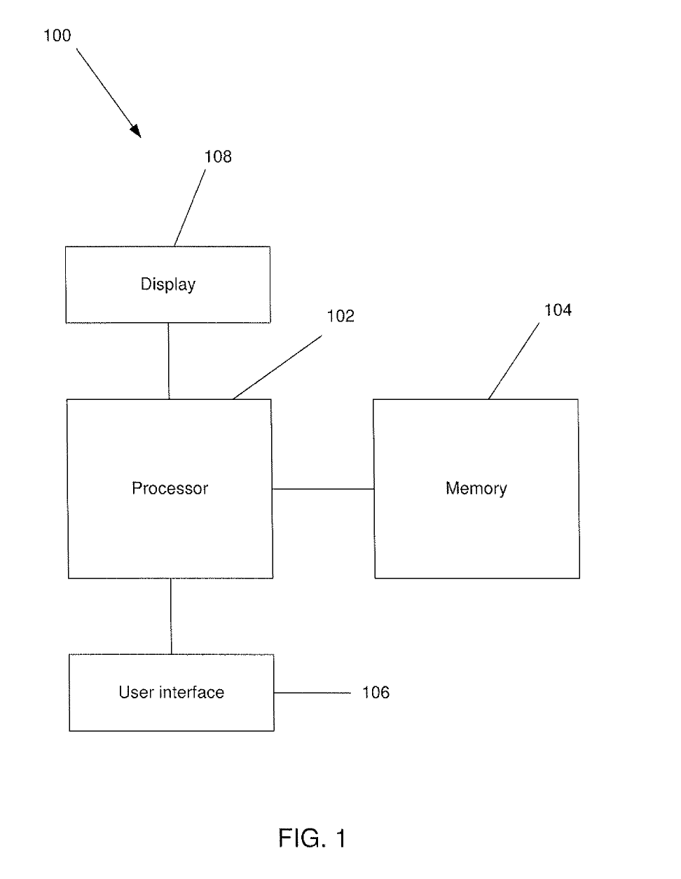

As shown in an exemplary embodiment in FIG. 1, a system 100 comprises a processor 102 and a memory 104. The memory 104 is any computer readable storage medium capable of storing a compilation of surface models of various organs that may be segmented. In one example, the memory 104 stores a database including the compilation of surface models of the various organs. The surface models may be a representative prototype of an organ being segmented or an average of many representative samples of the organ. A user selects one of the surface models from the memory 104 via a user interface 106. The selected model, along with any data inputted by a user via the user interface 106, is then processed using the processor 102 and displayed on a display 108. It will be understood by those of skill in the art that the system 100 is a personal computer, server or any other processing arrangement.

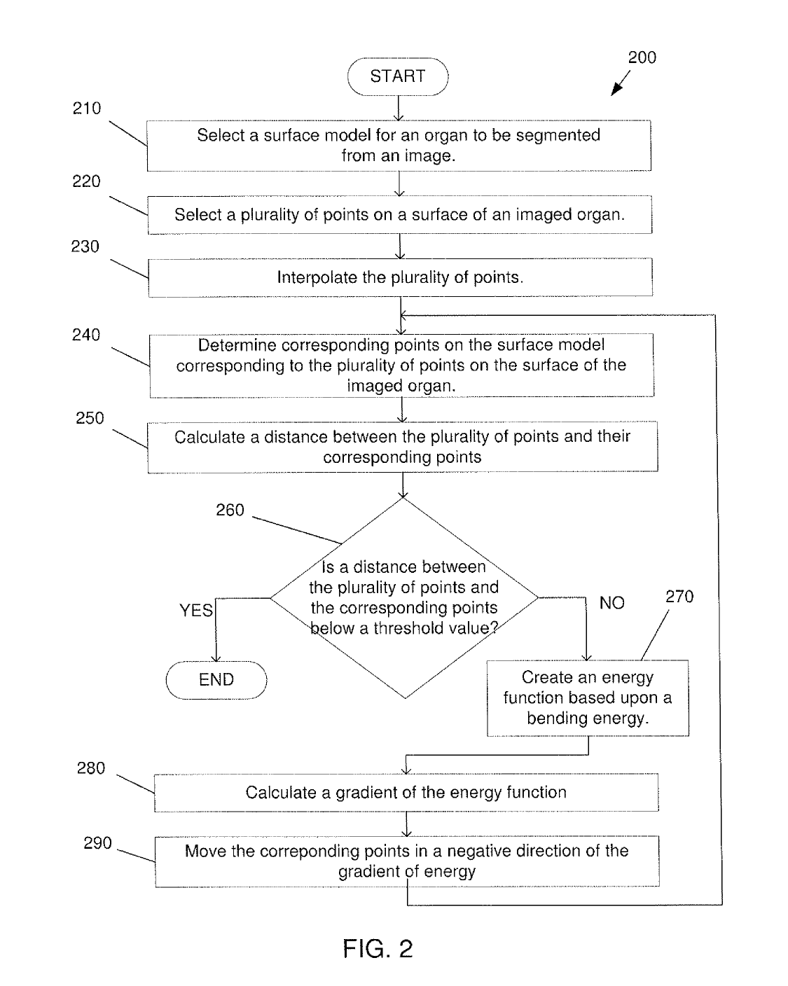

FIG. 2 shows a method 200 for segmenting an organ based on an image of the organ from an image acquired through CT, MRI or other medical imaging scan. Step 210 of the method 200 includes selecting a surface model of the organ to be segmented from the memory 104. The surface model may be a representative prototype or an average of several representative sample of the organ. Once the surface model has been selected, the surface model is displayed on the display 108. The surface model is appropriately positioned in the image and displayed on the display 108

In a step 220, the user selects a plurality of points on a surface of the imaged organ being segmented via the user interface 106. The user interface 106 includes, for example, a mouse to point to and click on the plurality of points on the surface. The plurality of points are selected from a surface of the imaged organ such that the plurality of points are interpolated in a step 230 to determined points falling in between the selected plurality of points to predict the surface. For example, when drawing a simple 2D contour, points can be interpolated because they are set in a certain order via mouse clicks or at regular time intervals. The points may be set in any order and in any reformatted view 2D view. It will therefore be understood by those of skill in the art that although any number of points may be selected in step 220, the greater the number of points that are selected, the more accurate the segmentation will be. Thus, the user may continue to select points until he/she is satisfied with the result. It will also be understood by those of skill in the art that a variety of methods may be used to select the plurality of points. For example, where the display 108 is touch sensitive, the user may select the plurality of points by touching a screen of the display 108. Once the plurality of points on the surface of the imaged organ have been selected, the surface model is mapped from a model-space to an image-space such that a transformation occurs, essentially aligning the surface model to the imaged organ. The complexity of the transformation is increased with the number of points selected.

Parameters for the transformation are determined using an iterative-closest-point algorithm. The parameters may be determined by optimization such that a bending energy is minimized at the same time the selected plurality of points are interpolated. For example, step 240 includes selecting points on the surface model, corresponding to the plurality of points on the image surface selected in the step 220. The corresponding points on the surface model may be the closest points on the surface model from each of the plurality of points selected on the imaged organ. It will be understood by those of skill in the art that the plurality of points on the image surface may be interpolated such that corresponding points on the surface of the model, which correspond to the interpolated points may also be determined. In a step 250, a distance between each of the plurality of points on the image surface and each of the corresponding points into the surface model is determined. It will be understood by those of skill in the art that the distance is defined by a Euclidean distance between each of the plurality of points on the image surface and each of the corresponding points on the surface of the model, which is a measure of the transformation that is required to align the corresponding points on the surface model to the plurality of points on the image surface. Specifically, distance is determined by the amount of translation that is required between each of the plurality of points on the image surface and their corresponding points on the surface model.

In a step 260, a convergence between the plurality of points of the imaged organ and their corresponding points on the surface model is monitored. The parameters of transformation are analyzed to determine whether a reiteration is required. For example, if a gradient of the transformation is deemed small enough (e.g., below a threshold value) such that any translation is negligible, it will be determined that no further iteration is necessary. It will be understood by those of skill in the art that such a negligible gradient would indicate that the surface model is substantially similar to the imaged organ. Thus, no further iteration is necessary and the segmentation is complete. If, however, the parameter of transformation is such that the gradient is substantive (e.g., above a threshold value), step 270 includes creating an energy function from the distance (e.g., bending energy) and an additional variable for the distances between the plurality of points on the imaged organ and the corresponding points on the surface model. It will be understood by those of skill in the art that a threshold value may be either predetermined or selected and entered by a user of the system 100.

A gradient of the energy function created in step 270 is calculated in a step 280. For example, the energy function may be represented by the formula, E=E_{D}+E_{B}, where E_{D} is a sum of the Euclidean distance between each of the plurality of points of the image surface and a transformation of each of the corresponding points of the surface model and E_{B} is the bending energy, which depends on the paramterization of the transformation. Once this gradient is calculated, each of the corresponding points on the surface model, are moved in a negative direction by the calculated gradient, in a step 290, such that the surface model is closer to the imaged organ. The gradient of energy is calculated with respect to the parameters of transformation. It will be understood by those of skill in the art that since the plurality of points have been interpolated and corresponding points determined accordingly in step 240, an entire surface of the surface model moves in the negative direction, placing the surface model in greater alignment with the imaged organ. Once the surface model has been moved, the method 200 may return to step 230, where corresponding points on the surface model, closest to the selected plurality of points, are determined. Thus, it will be understood by those of skill in the art that the iterative process may be repeated until the distance between each of the selected plurality of points and the corresponding points on the surface model are below a threshold value. Once the distance of the corresponding points from the plurality of points is always below the threshold value, the surface model is considered to be aligned with the imaged organ such that segmentation is complete.

Once the segmentation is complete, it will be understood by those of skill in the art that the segmented organ may be saved to a memory of the system 100. In particular, the segmented organ may be saved in the memory 104 as a representative prototype. Where the surface models of the memory 104 are an average of many representative prototypes, the segmented organ may be included and averaged with other representative prototypes to determine the average.

It is noted that the exemplary embodiments or portions of the exemplary embodiments may be implemented as a set of instructions stored on a computer readable storage medium, the set of instructions being executable by a processor.

It will be apparent to those skilled in the art that various modifications may be made without departing from the spirit or scope of the present disclosure. Thus, it is intended that the present disclosure cover modifications and variations provided they come within the scope of the appended claims and their equivalents.

It is also noted that the claims may include reference signs/numerals in accordance with PCT Rule 6.2 (b). However, the present claims should not be considered to be limited to the exemplary embodiments corresponding to the reference signs/numerals.

What is claimed is:

1. A method for segmenting an organ, comprising:
selecting (210) a surface model of the organ;
selecting (220) a plurality of points on a surface of an image of the organ; and
transforming (230-290) the surface model to the plurality of points on the image.

2. The method of claim 1, wherein transforming the surface model to the plurality of points on the image includes interpolating (230) the plurality of points to determine points between the selected plurality of points and predict a surface of the image of the organ.

3. The method of claim 1, wherein transforming the surface model to the plurality of points on the image includes determining (240) corresponding points on the surface model for each of the plurality of points.

4. The method of claim 3, wherein the corresponding points are points on the surface model which are closest to each of the plurality of points.

5. The method of claim 1, wherein transforming the surface model to the plurality of points on the image includes determining (250) a distance between each of the plurality of points and the corresponding points.

6. The method of claim 5, wherein when each of the distances is below a threshold value (260), segmentation of the organ is complete.

7. The method of claim 5, wherein when at least one of the distances is one of at and above the threshold value (260), creating (270) an energy function as a function of the distance.

8. The method of claim 7, further comprising:
calculating (280) a gradient of the energy function.

9. The method of claim 8, further comprising:
moving (290) the corresponding points in a negative direction of the gradient of the energy function.

10. The method of claim 9, wherein an entire surface of the surface model moves in the negative direction of the gradient of the energy function.

11. A system for segmenting an organ, comprising:
a memory (104) storing a compilation of surface models to be selected;
a user interface (106) adapted to allow a user to select a surface model from the memory and select a plurality of points on a surface of an image of the organ; and
a processor (102) transforming the surface model to the plurality of points on the image.

12. The system of claim 11, further comprising:
a display (108) displaying at least one of compilation of surface models from the memory (104), the selected surface model and the image of the organ.

13. The system of claim 11, wherein the user interface (106) is a touch screen on the display (108).

14. The system of claim 11, wherein the user interface (106) includes a mouse for selecting the plurality of points.

15. The system of claim 11, wherein the compilation of surface models stored in the memory (104) includes representative prototypes of the organ to be segmented.

16. The system of claim 11, wherein the compilation of surface models stored in the memory (104) include an average of representative prototypes of the organ to be segmented.

17. The system of claim 11, wherein the processor (102) in transforming the surface model to the plurality of points on the image, interpolates the plurality of points to determine points between the selected plurality of points and predict a surface of the image of the organ.

18. The system of claim 11, wherein the processor (102) in transforming the surface model to the plurality of points on the image, determines corresponding points on the surface model for each of the plurality of points.

19. The system of claim 11, wherein the processor (102) in transforming the surface model to the plurality of points on the image, determines a distance between each of the plurality of points and the corresponding points.

20. A computer readable storage medium (104) including a set of instructions executable by a processor (102), the set of instructions operable to:
select (210) a surface model of the organ;
select (220) a plurality of points on a surface of an image of the organ; and
transform (230-290) the surface model to the plurality of points on the image.
